(19) United States
(12) Patent Application Publication
(10) Pub. No.: US 2010/0322624 A1
(43) Pub. Date: Dec. 23, 2010

(54) BIDIRECTIONAL TRANSMISSION NETWORK APPARATUS BASED ON TUNABLE RARE-EARTH-DOPED FIBER LASER

(75) Inventors: CHENG-KUANG LIU, Taipei City (TW); SAN-LIANG LEE, Taipei City (TW); CHIH-LUNG TSENG, Taipei City (TW); JAU-JI JOU, Taipei City (TW); SHU-CHUAN LIN, Taipei City (TW)

Correspondence Address: WPAT, PC;INTELLECTUAL PROPERTY ATTORNEYS, 7225 BEVERLY ST., ANNANDALE, VA, 22003, US

(73) Assignee: National Taiwan University of Science and Technology, Taipei City (TW)

(21) Appl. No.: 12/196,378

(22) Filed: Aug. 22, 2008

(51) Int. Cl. H04B 10/24; H01S 3/30

(52) U.S. Cl. 398/41; 372/6

(57) ABSTRACT

The present invention discloses a bidirectional transmission network apparatus based on a tunable rare-earth-doped fiber laser source. It is useful in wavelength-division-multiplexing access networks. The fiber ring laser not only generates downstream data traffic but also serves as the wavelength-selecting injection light source for the Fabry-Pérot lasers (or vertical cavity surface emitting lasers) located at the subscriber site. The fiber laser is constructed based on optical filtering, polarization control and noise suppression techniques.

### BACKGROUND OF THE INVENTION

1. Field of the Invention

The present invention generally relates to a bidirectional transmission network apparatus based on a tunable rare-earth-doped fiber laser, and, more particularly, to a passive optical network structure based on a Fabry-Pérot laser (or a vertical-cavity surface-emitting laser) injection-locked by the tunable rare-earth doped-fiber laser capable of being used as a downstream laser source at the central office (CO) of an optical fiber network and as a wavelength-selecting injection source for the upstream lasers at the subscriber site.

2. Description of the Prior Art

The demand in network capacity is increased due to intensive Internet usage, especially, through the wavelength-division multiplexing (WDM) access networks providing fiber-to-the-home (FTTH) triple-play service integrating audio, data and video signals. Therefore, each optical network unit (ONU) at the subscriber site requires a laser with a respective wavelength, which is capable of modulating uploaded data. This makes the passive optical network (PON) relatively expensive in the WDM system.

Conventionally, the light-emitting diode and the reflective semiconductor optical amplifier are used as light sources of optical network units (ONU's) at the subscriber site, which however leads to higher cost and requires complicated packaging. Recently, the injection-locked Fabry-Pérot (FP) laser is used as a light source of optical network units (ONU's) at the subscriber site because the Fabry-Pérot (FP) laser is less costly and requires simplified packaging. At the central office (CO) of an optical fiber network, the distributed feedback laser (DFB) and the amplified spontaneous emission (ASE) light source are used as light sources to be fed through an arrayed waveguide grating (AWG) into the FP laser. However, the former is problematic that the light source is temperature-sensitive and relatively costly, and the latter is disadvantageous that the arrayed waveguide grating requires precise temperature control.

Therefore, there is need in providing a tunable rare-earth doped-fiber laser capable of being used as a high-quality, adjustable and low-cost laser source at the central office (CO) and as a wavelength-selecting injection source for the upstream lasers at the subscriber site.

### SUMMARY OF THE INVENTION

It is one object of the present invention to provide a bidirectional transmission network apparatus based on a tunable rare-earth-doped fiber laser injection-locked by a tunable laser wavelength to achieve bidirectional data transmission. The fiber laser not only generates downstream data traffic but also serves as the wavelength-selecting injection light source at the subscriber site for upstream signals. The tunable rare-earth-doped-fiber laser is useful in applications such as fiber-to-the-home (FTTH), wavelength-division multiplexing (WDM) access networks and passive optical networks (PONs).

In order to achieve the foregoing object, the present invention provides a bidirectional transmission network apparatus based on a tunable rare-earth-doped fiber laser, the bidirectional transmission network apparatus comprising: an office center (CO) module, comprising the tunable rare-earth-doped fiber laser; a remote node (RN) module, comprising an optical de-multiplexer and an optical multiplexer, each coupled to the office center module through a single-mode fiber; an optical network unit (ONU) module, comprising a semiconductor laser injection-locked by the tunable rare-earth-doped fiber laser.

In order to achieve the foregoing object, the present invention further provides a tunable rare-earth-doped-fiber laser, comprising: a pump laser diode, capable of providing pumping power; a wavelength-division multiplexer, coupled to the pump laser diode; a rare-earth-doped fiber, coupled to the wavelength-division multiplexer, so that the pump laser diode provides the rare-earth-doped fiber with the pumping power through the wavelength-division multiplexer to generate a wide-band amplified spontaneous emission (ASE) light; an optical tunable filter, coupled to the rare-earth-doped fiber to filter the wide-band amplified spontaneous emission light to generate a laser light with a determined wavelength, wherein the optical tunable filter is adjustable to determine the wavelength; a first optical circulator, coupled to the optical tunable filter to confine the propagation direction of the laser light; an optical polarization controller, coupled to the first optical circulator to control the polarization of the laser light; a semiconductor optical amplifier, coupled to the optical polarization controller to suppress noise from the laser light; an optical coupler, coupled to the semiconductor optical amplifier to split and couple out the laser light; and a second optical circulator, coupled to the optical coupler to confine the propagation direction of the laser light.

Thereby, the tunable rare-earth-doped fiber laser of the present invention does not only generate downstream data traffic but also serve as the wavelength-selecting injection light source at the subscriber site for upstream signals.

### BRIEF DESCRIPTION OF THE DRAWINGS

The objects, spirits and advantages of the preferred embodiment of the present invention will be readily understood by the accompanying drawings and detailed descriptions, wherein:

FIG. 1 is a systematic diagram showing a bidirectional transmission network apparatus based on a tunable rare-earth-doped fiber laser as a downstream laser source and as an upstream laser source according to the present invention, wherein a Fabry-Pérot laser is injection-locked by the tunable rare-earth-doped fiber laser;

FIG. 2 shows the optical spectra of the output power of the tunable rare-earth-doped fiber laser according to the present invention;

FIG. 3 shows the optical spectra of the output power of the Fabry-Pérot laser injection-locked by the tunable rare-earth-doped fiber laser according to the present invention;

FIG. 4 shows the bit error rate versus received optical power for 10 Gb/s downstream data transmitted over a 10-km single-mode fiber; and

FIG. 5 shows the bit error rate versus received optical power for 1.25 Gb/s upstream data transmitted over a 10-km single-mode fiber.

### DETAILED DESCRIPTION OF THE PREFERRED EMBODIMENT

The present invention can be exemplified by the preferred embodiments as described hereinafter.

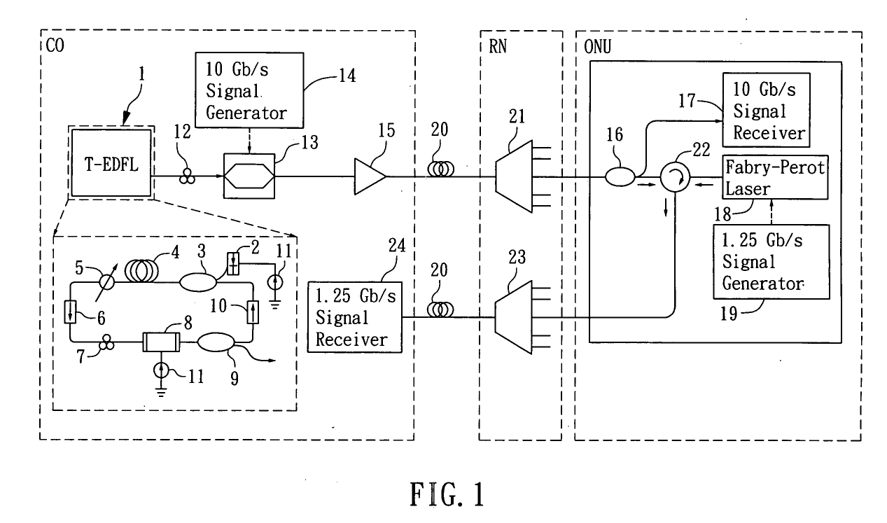

Please refer to FIG. 1, which is a systematic diagram showing a bidirectional transmission network apparatus based on a tunable rare-earth-doped fiber laser 1 as a downstream laser source and as an upstream laser source according to the present invention, wherein a Fabry-Pérot laser 18 is injection-locked by the tunable rare-earth-doped fiber laser 1. The bidirectional transmission network apparatus comprises: an office center (CO) module, comprising the tunable rare-earth-doped fiber laser 1; a remote node (RN) module, comprising an optical de-multiplexer 21 and an optical multiplexer 23, each coupled to the OC module through a single-mode fiber 20; an optical network unit (ONU) module, comprising a semiconductor laser 18 injection-locked by the tunable rare-earth-doped fiber laser 1.

Referring to FIG. 1, the tunable rare-earth-doped-fiber laser 1 comprises: a pump laser diode 2 to provide pumping power; a wavelength-division multiplexer 3, coupled to the pump laser diode 2; an rare-earth-doped fiber 4, coupled to the wavelength-division multiplexer 3, so that the pump laser diode 2 provides the rare-earth-doped fiber 4 with the pumping power through the wavelength-division multiplexer 3 to generate a wide-band amplified spontaneous emission (ASE) light; an optical tunable filter 5, coupled to the rare-earth-doped fiber 4 to filter the wide-band amplified spontaneous emission light to generate a laser light with a determined wavelength, wherein the optical tunable filter 5 is adjustable to determine the wavelength; a first optical circulator 6, coupled to the optical tunable filter 5 to confine the propagation direction of the laser light; an optical polarization controller 7, coupled to the first optical circulator 6 to control the polarization of the laser light; a semiconductor optical amplifier 8, coupled to the optical polarization controller 7 to suppress noise from the laser light; an optical coupler 9, coupled to the semiconductor optical amplifier 8 to split and couple out the laser light; and a second optical circulator 10, coupled to the optical coupler 9 to confine the propagation direction of the laser light. A power supply 11 provides the pump laser diode 2 and the semiconductor optical amplifier 8 with required power. In the preferred embodiment of the present invention, the wavelength-division multiplexer 3, the rare-earth-doped fiber 4, the optical tunable filter 5, the first optical circulator 6, the optical polarization controller 7, the semiconductor optical amplifier8, the optical coupler 9 and the second optical circulator 10 are connected in a ring configuration. Preferably, the pump laser diode 2 is exemplified by, but not limited to, a 980-nm pump laser diode. Preferably, the rare-earth-doped fiber 4 is exemplified by, but not limited to, an erbium-doped fiber. Preferably, the optical coupler 9 is exemplified by, but not limited to, a 10:90 optical coupler to couple out the split laser light with 10% of the power and guide the split laser light with 90% of the power back to the second optical circulator 10.

Since the tunable rare-earth-doped-fiber laser 1 of the present invention is configured as a ring, it is used for both the high-speed downstream data from the center office and the upstream data from the subscriber site. Therefore, the split and coupled laser light from the optical coupler 9 is suitable for use as a laser source in optical fiber networks, WDM access networks or passive optical networks. Meanwhile, the split and coupled laser light from the optical coupler 9 is suitable for use as a laser source for wavelength conversion or to be injection-locked with a Fabry-Pérot laser or a vertical cavity surface-emitting laser (VCSEL) so that the signal from the wavelength conversion device, the Fabry-Pérot laser or the vertical cavity surface-emitting laser can be modulated to generate upstream data traffic to the center office. Since the wavelength of the tunable fiber laser is tunable, it can be used in networks with dynamic wavelength. By tuning the optical tunable filter 5, the wavelength of the laser can be determined. The optical polarization controller 7 is adjustable so that the power of the laser light is independent of the wavelength. The wavelength of the tunable rare-earth-doped-fiber laser is in the C-band or the L-band, while the Fabry-Pérot laser and the vertical cavity surface-emitting laser source also work in the C-band or the L-band.

In the present invention, the laser light from the tunable rare-earth-doped-fiber laser 1 passes through the optical polarization controller 12 and is then modulated by an electro-optic modulator 13 with a 10-Gb/s signal from a 10-Gb/s signal generator 14. After the modulated laser light is amplified by an rare-earth-doped fiber amplifier 15, it passes through a 10-km single-mode fiber 20 and is de-multiplexed by an optical de-multiplexer 21 before it is received by a 10-Gb/s signal receiver 17 of an optical network unit (ONU) at the subscriber site. Meanwhile, the laser light is split by an optical coupler 16 into two optical paths. One is coupled to the 10-Gb/s signal receiver 17 for downstream data, while the other is coupled to an optical circulator 22, which is fed with a Fabry-Pérot laser 18 (or a vertical cavity surface-emitting laser) of an optical network unit (ONU) at the subscriber site for wavelength locking so that the Fabry-Pérot laser 18 (or the vertical cavity surface-emitting laser) is capable of modulating a 1.25-Gb/s signal from a 1.25-Gb/s signal generator 19 at a high speed. The optical circulator 22 is also coupled to an optical multiplexer 23 for upstream data through a 10-km single-mode fiber 20 back to a 1.25-Gb/s signal receiver 24 at the center office.

The downstream laser at the center office is coupled to different optical network units (ONUs) at the subscriber site through the optical de-multiplexer 21 at the remote node (RN). The optical circulator 22 is used to determine the upstream optical path. The upstream laser at the subscriber site is coupled to the center office through the multiplexer 23 at the remote node (RN).

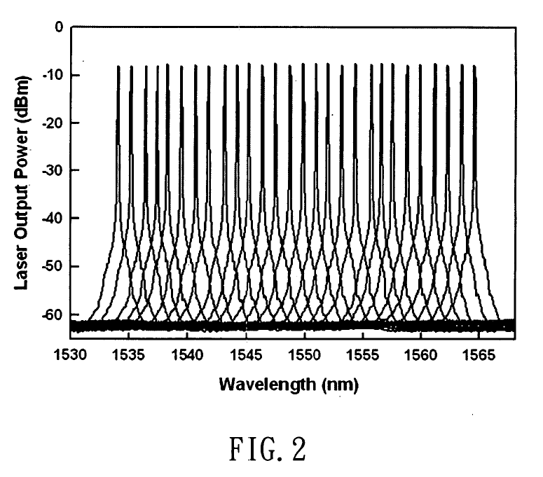

In order to realize the advantages of the present invention, please refer to FIG. 2 to FIG. 5. FIG. 2 shows the optical spectra of the output power of the tunable rare-earth-doped fiber laser according to the present invention. The average output power of the laser is −7.7 dBm. The variation in the maximum power is smaller than 0.6 dB and the signal-to-noise ratio is above 53 dB. In FIG. 2, the tunable rare-earth-doped fiber laser has a tuning range from 1534 to 1564 nm and a 1.3-nm wavelength spacing to match the mode spacing of the Fabry-Pérot laser.

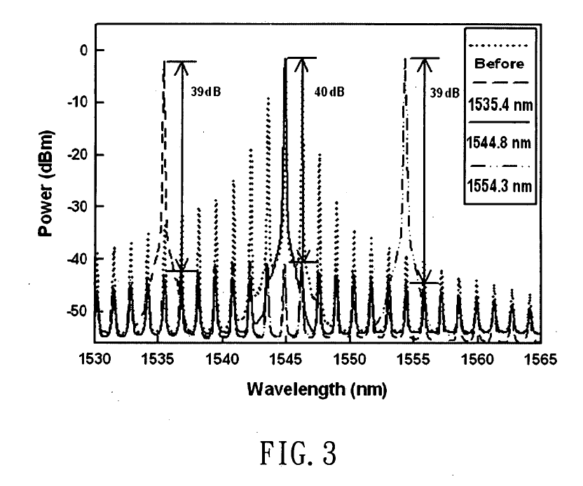

FIG. 3 shows the optical spectra of the output power of the Fabry-Pérot laser injection-locked by the tunable rare-earth-doped fiber laser according to the present invention. In FIG. 3, the Fabry-Pérot laser is biased at 20 mA, the dotted curve indicates a spectral mode spacing before injection-locking and the solid curve shows the spectrum of the Fabry-Pérot laser injection-locked at 1544.8 nm. It is noted that the Fabry-Pérot laser turns into a single-mode laser from a multi-mode laser after it is injection-locked so that the upstream data can be modulated and transmitted back to the center office.

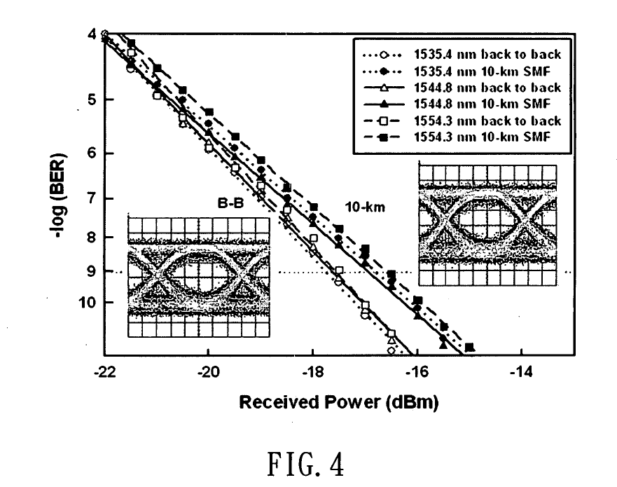

FIG. 4 shows the bit error rate versus received optical power for 10 Gb/s downstream data transmitted over a 10-km single-mode fiber. In FIG. 4, bidirectional transmission is realized for downstream signals at 10 Gb/s over a 10-km single-mode fiber with power penalty of 0.9 dB.

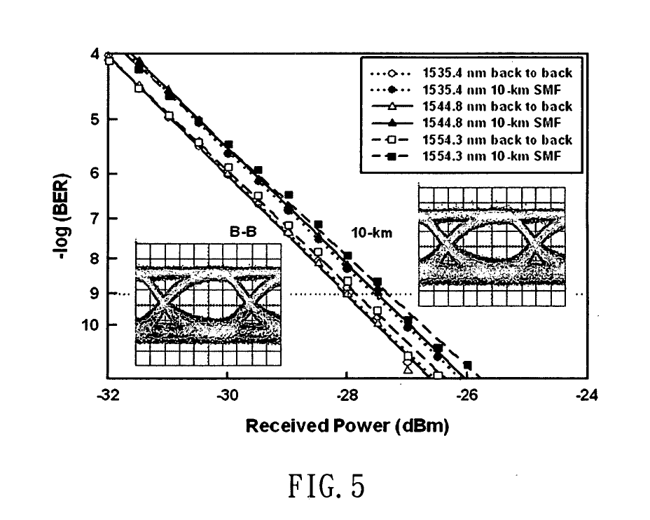

FIG. 5 shows the bit error rate versus received optical power for 1.25 Gb/s upstream data transmitted over a 10-km single-mode fiber. In FIG. 5, similarly, bidirectional transmission is realized for upstream signals at 1.25 Gb/s over a 10-km single-mode fiber with power penalty of 0.5 dB.

Therefore, in the present invention, the tunable rare-earth doped-fiber laser is configured as a ring and is capable of being used both as a downstream laser source at the central office (CO) of an optical fiber network and as a wavelength-selecting injection source for the upstream lasers at the subscriber site. The fiber laser is constructed based on optical filtering, polarization control and noise suppression techniques. An example is shown by using an optical polarization controller, a semiconductor optical amplifier, and an optical tunable filter. Moreover, it is wavelength tunable and can be applied to dynamic wavelength assignment networks. The fiber laser having a tunable wavelength range in the C band (and/or L band) are adopted for the Fabry-Pérot lasers working in the C-band (and/or L band). The passive optical network is employed to link the fiber laser and Fabry-Pérot lasers (or vertical-cavity surface-emitting lasers) injection-locked by the fiber laser. Downstream wavelength at the subscriber site is selected by an optical demultiplexer or wavelength router. A circulator is employed for the flow control of the downstream and upstream signals. Downstream signal at 10 Gb/s and upstream signal at 1.25 Gb/s can be transmitted over 10-km single-mode fiber with power penalties of 0.9 dB and 0.5 dB, respectively. A longer transmission distance is also possible.

Accordingly, the present invention discloses a bidirectional transmission network apparatus based on a tunable rare-earth-doped fiber laser to achieve high-speed data transmission with lowered manufacturing cost. Therefore, the present invention is novel, useful and non-obvious.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A bidirectional transmission network apparatus based on a tunable rare-earth-doped fiber laser, the bidirectional transmission network apparatus comprising:
an office center (CO) module, comprising the tunable rare-earth-doped fiber laser;
a remote node (RN) module, comprising an optical de-multiplexer and an optical multiplexer, each coupled to the office center module through a single-mode fiber;
an optical network unit (ONU) module, comprising a semiconductor laser injection-locked by the tunable rare-earth-doped fiber laser.

2. The bidirectional transmission network apparatus as recited in claim 1, wherein the semiconductor laser is one of a Fabry-Pérot laser and a vertical cavity surface emitting laser (VCSEL).

3. The bidirectional transmission network apparatus as recited in claim 1, wherein the office center (CO) module further comprises:
an optical polarization controller, coupled to the tunable rare-earth-doped fiber laser;
an electro-optic modulator, coupled to the optical polarization controller to modulate data generated by a 10-Gb/s signal generator;
a rare-earth-doped fiber amplifier; and
a 1.25 Gb/s signal generator, coupled to the optical multiplexer through the single-mode fiber.

4. The bidirectional transmission network apparatus as recited in claim 1, wherein the tunable rare-earth-doped-fiber laser comprises:
a pump laser diode, capable of providing pumping power;
a wavelength-division multiplexer, coupled to the pump laser diode;
a rare-earth-doped fiber, coupled to the wavelength-division multiplexer, so that the pump laser diode provides the rare-earth-doped fiber with the pumping power through the wavelength-division multiplexer to generate a wide-band amplified spontaneous emission (ASE) light;
an optical tunable filter, coupled to the rare-earth-doped fiber to filter the wide-band amplified spontaneous emission light to generate a laser light with a determined wavelength, wherein the optical tunable filter is adjustable to determine the wavelength;
a first optical circulator, coupled to the optical tunable filter to confine the propagation direction of the laser light;
an optical polarization controller, coupled to the first optical circulator to control the polarization of the laser light;
a semiconductor optical amplifier, coupled to the optical polarization controller to suppress noise from the laser light;
an optical coupler, coupled to the semiconductor optical amplifier to split and couple out the laser light; and
a second optical circulator, coupled to the optical coupler to confine the propagation direction of the laser light.

5. The bidirectional transmission network apparatus as recited in claim 4, wherein the rare-earth-doped fiber is an erbium-doped fiber.

6. The bidirectional transmission network apparatus as recited in claim 4, wherein the wavelength-division multiplexer, the rare-earth-doped fiber, the optical tunable filter, the first optical circulator, the optical polarization controller, the semiconductor optical amplifier, the optical coupler and the second optical circulator are connected in a ring configuration.

7. The bidirectional transmission network apparatus as recited in claim 4, wherein the split and coupled laser light from the optical coupler is used as a laser source for optical fiber networks.

8. The bidirectional transmission network apparatus as recited in claim 7, wherein the split and coupled laser light from the optical coupler is used as a laser source for wavelength-division multiplexing (WDM) access networks.

9. The bidirectional transmission network apparatus as recited in claim 8, wherein the split and coupled laser light from the optical coupler is used as a laser source for passive optical networks with bidirectional transmission.

10. The bidirectional transmission network apparatus as recited in claim 4, wherein the optical tunable filter is adjustable to generate a laser light with a determined wavelength in the C-band and/or the L-band.

11. The bidirectional transmission network apparatus as recited in claim 10, wherein the optical polarization controller is adjustable so that the power of the laser light is independent of the wavelength.

12. The bidirectional transmission network apparatus as recited in claim 4, wherein the split and coupled laser light from the optical coupler is used as a laser source for wavelength conversion.

13. The bidirectional transmission network apparatus as recited in claim 4, wherein the pump laser diode is a 980-nm pump laser diode.

14. The bidirectional transmission network apparatus as recited in claim 4, wherein the optical coupler is a 10:90 optical coupler to couple out the split laser light with 10% of the power.

15. A tunable rare-earth-doped-fiber laser, comprising:
a pump laser diode, capable of providing pumping power;
a wavelength-division multiplexer, coupled to the pump laser diode;
a rare-earth-doped fiber, coupled to the wavelength-division multiplexer, so that the pump laser diode provides the rare-earth-doped fiber with the pumping power through the wavelength-division multiplexer to generate a wide-band amplified spontaneous emission (ASE) light;
an optical tunable filter, coupled to the rare-earth-doped fiber to filter the wide-band amplified spontaneous emission light to generate a laser light with a determined wavelength, wherein the optical tunable filter is adjustable to determine the wavelength;
a first optical circulator, coupled to the optical tunable filter to confine the propagation direction of the laser light;
an optical polarization controller, coupled to the first optical circulator to control the polarization of the laser light;
a semiconductor optical amplifier, coupled to the optical polarization controller to suppress noise from the laser light;
an optical coupler, coupled to the semiconductor optical amplifier to split and couple out the laser light; and
a second optical circulator, coupled to the optical coupler to confine the propagation direction of the laser light.

16. The tunable rare-earth-doped-fiber laser as recited in claim 15, wherein the rare-earth-doped fiber is an erbium-doped fiber.

17. The tunable rare-earth-doped-fiber laser as recited in claim 15, wherein the wavelength-division multiplexer, the rare-earth-doped fiber, the optical tunable filter, the first optical circulator, the optical polarization controller, the semiconductor optical amplifier, the optical coupler and the second optical circulator are connected in a ring configuration.

18. The tunable rare-earth-doped-fiber laser as recited in claim 15, wherein the split and coupled laser light from the optical coupler is used as a laser source for optical fiber networks.

19. The tunable rare-earth-doped-fiber laser as recited in claim 18, wherein the split and coupled laser light from the optical coupler is used as a laser source for wavelength-division multiplexing (WDM) access networks.

20. The tunable rare-earth-doped-fiber laser as recited in claim 19, wherein the split and coupled laser light from the optical coupler is used as a laser source for passive optical networks with bidirectional transmission.

21. The tunable rare-earth-doped-fiber laser as recited in claim 15, wherein the optical tunable filter is adjustable to generate a laser light with a determined wavelength in the C-band and/or the L-band.

22. The tunable rare-earth-doped-fiber laser as recited in claim 21, wherein the optical polarization controller is adjustable so that the power of the laser light is independent of the wavelength.

23. The tunable rare-earth-doped-fiber laser as recited in claim 15, wherein the split and coupled laser light from the optical coupler is used as a laser source for wavelength conversion.

24. The tunable rare-earth-doped-fiber laser as recited in claim 15, wherein the pump laser diode is a 980-nm pump laser diode.

25. The tunable rare-earth-doped-fiber laser as recited in claim 15, wherein the optical coupler is a 10:90 optical coupler to couple out the split laser light with 10% of the power.
